(19) United States
(12) Patent Application Publication
(10) Pub. No.: US 2018/0002936 A1
(43) Pub. Date: Jan. 4, 2018

(54) Concrete Form Clip

(71) Applicant: Paul Murphy, Hastings, MN (US)

(72) Inventor: Paul Murphy, Hastings, MN (US)

(21) Appl. No.: 15/636,193

(22) Filed: Jun. 28, 2017

Related U.S. Application Data
(60) Provisional application No. 62/356,136, filed on Jun. 29, 2016.

(51) Int. Cl. E04G 17/02; F16B 2/12; F16B 2/22; E04G 13/06

(52) U.S. Cl. CPC E04G 17/02; F16B 2/22; F16B 2/12; E04G 13/06

(57) ABSTRACT

A concrete form clip includes a main clip body, a first channel, a second channel, and at least one anchoring feature so that the concrete form clip can receive a form mat and secure to the ground surface. The first channel is terminally connected to the main clip body from top, and the second channel is terminally connected to the main clip body from bottom. As a result, the main clip body, the first channel, and the second channel are able to receive the form mat. The concrete form clip can be secured to the ground surface with the at least one anchoring feature through a wooden stake and/or a metal stake. The form mat and multiple concrete form clips collectively delineate the section shape of the area that concrete is poured.

The current application claims a priority to the U.S. Provisional Patent application serial number 62/356,136 filed on Jun. 29, 2016.

### FIELD OF THE INVENTION

The present invention relates generally to concrete form clip which can secure a form mat. More particularly, the present invention is a concrete form clip which can receive a form mat, and also stakes to pin down and secure form mats to create sections for concrete mix to be poured into.

### BACKGROUND OF THE INVENTION

Creating concrete pathways, stairs, and/or structures are not an easy task. The usual methods include the use of concrete form assembly which implement plywood panels. The concrete form assembly procedures a section shape, wherein concrete can be poured into to create a solid concrete that solidifies into the shape of the section formed. Many concrete form assemblies implement spacers in order to secured the panels and create a section shape. The downfall of this method is that the spacers are of a pre-determined length which limits what section shapes the user can create and design.

It is therefore an objective of the present invention, to provide concrete form clips which can secure separate form mats eliminating any limits and opening up many possibilities for section shapes which can be created. The present invention includes non-slip pieces to prevent the form mat from moving while engaged with the present invention and receiving sections to receive a form mat. The present invention also includes a clip guide to easily secure a form and includes an embodiment with an adjustable clip unit to secure form mats of varying sizes. The present invention also includes stake openings to firmly pin down the form mats to the ground.

### BRIEF DESCRIPTION OF THE DRAWINGS

FIG. 1 is a perspective view of the preferred embodiment of the present invention.

FIG. 2 is a side view of the preferred embodiment of the present invention.

FIG. 3 is a detail view of the preferred embodiment of the present invention, showing the acute angle between the second channel and the guide plate.

FIG. 4 is a perspective view of the alternative embodiment of the present invention.

FIG. 5 is a side view of the alternative embodiment of the present invention.

FIG. 6 is another side view of the alternative embodiment of the present invention.

### DETAIL DESCRIPTIONS OF THE INVENTION

All illustrations of the drawings are for the purpose of describing selected versions of the present invention and are not intended to limit the scope of the present invention.

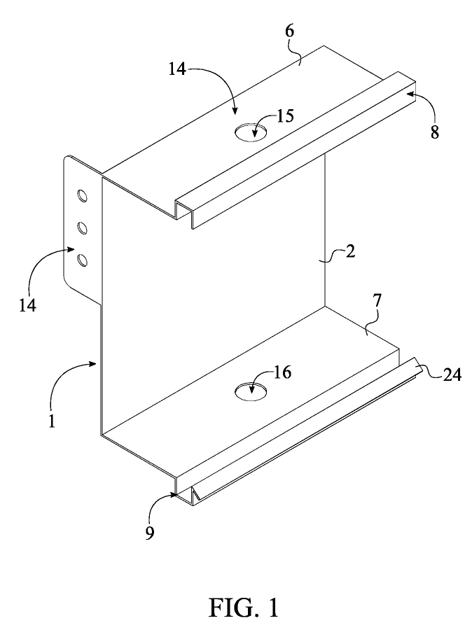

The present invention is a concrete form clip that is utilized to create concrete pathways, stairs, and other similar types of structures. The present invention is secured to the ground surface through multiple securing mechanism and is designed to receive a form mat as the form mat delineates the designated shape of a concrete structure to be completed. Depending upon the length and the shape of a concrete structure, multiple concrete form clips are generally utilized along the length of the form mat. For example, when the form mat is positioned as a straight line, concrete clips are equally spaced apart from each other along the form mat to appropriately support thus securing the form mat to the ground surface. When the form mat is positioned as a curved line, concrete clips are selectively spaced apart from each other to create necessary bends throughout the form mat thus securing the from mat to the ground surface. In reference to FIG. 1, the present invention comprises a main clip body 1, a first channel 8, a second channel 9, and at least one anchoring feature 14 as the main clip body 1 comprises an elongated plate 2, a first arm 6, and a second arm 7.

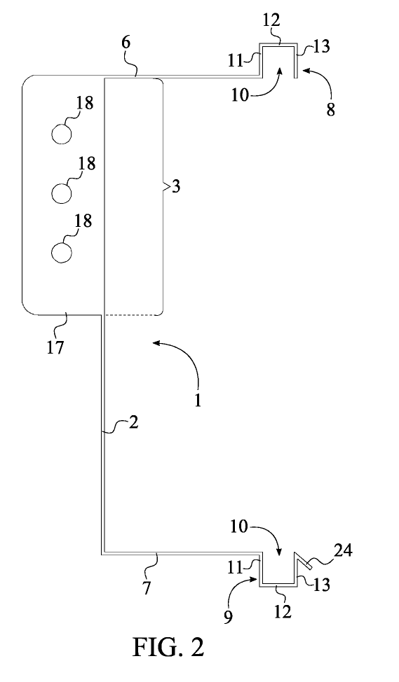

The main clip body 1 functions as the core member for the present invention and preferably shaped into a rectangular shape to properly support the form mat. In reference to FIG. 1-2, the first arm 6 and the second arm 7 are perpendicularly and terminally connected to the elongated plate 2 as they are oriented parallel to each other along elongated plate 2. The first arm 6 and the second arm 7 are also preferably shaped into rectangular shapes. As a result, the elongated plate 2, the first arm 6, and the second arm 7 delineate a U-shaped profile for the main clip body 1. More specifically, the first arm 6 is positioned at a top edge of the main clip body 1 as the first arm 6 is extended away from the main clip body 1 at a right angle. The second arm 7 is positioned at a bottom edge of the main clip body 1 as the second arm 7 is extended away from the main clip body 1 at a right angle.

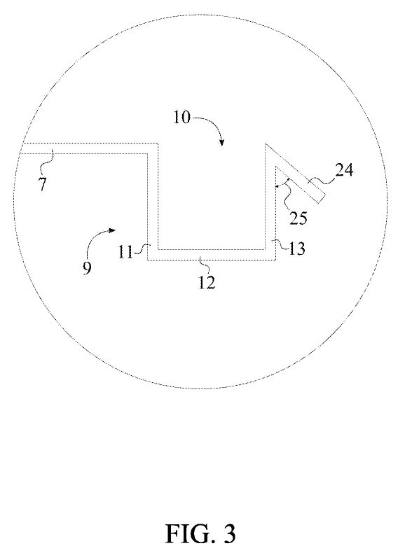

The first channel 8 and the second channel 9 collectively secure the form mat to the main clip body 1 from top and bottom so that the form mat can be positioned normal to the ground surface. In reference to FIG. 2, the first channel 8 is terminally connected along the first arm 6 and positioned opposite of the elongated plate 2. The second channel 9 is terminally connected along the second arm 7 and positioned opposite of the elongated plate 2. The first channel 8 and the second channel 9 each comprises a fixed wall 11, a base 12, a free wall 13, and a channel opening 10 as shown in FIG. 3. More specifically, the fixed wall 11 of the first channel 8 is perpendicularly connected to the first arm 6 thus positioning the first channel 8 adjacent to the first arm 6. The fixed wall 11 of the second channel 9 is perpendicularly connected to the second arm 7 thus positioning the second channel 9 adjacent to the second arm 7. The free wall 13 is connected to the fixed wall 11 by the base 12 and is positioned parallel to the fixed wall 11, completing a U-shaped profile for the first channel 8 and the second channel 9. Due to the configuration of the fixed wall 11, the base 12, and the free wall 13 for the first channel 8 and the second channel 9, the channel opening 10 of the first channel 8 and the second channel 9 are oriented towards each other along the elongated plate 2. As a result, the first channel 8 and the second channel 9 provide seamless insertion for flat ends of the form mat within the present invention. In an alternative embodiment of the present invention, the overall profile of the first channel 8 and the second channel 9 can be a semi-circular in order to accept rounded ends of the form mat.

In reference to FIG. 1, the at least one anchoring feature 14 is integrated onto the main clip body 1. However, depending upon different embodiment and desired intentions, the present invention can have single or multiple anchoring features 14. Due to component differences of the at least one anchoring feature 14, the respective anchoring feature is hereinafter described in relations to respective embodiments of the present invention.

In reference to a preferred embodiment of the present invention, the elongated plate 2 is a single plate and manufactured to a predetermined height as shown in FIG. 1-2. As a result, the distance between the first channel 8 and the second channel 9 is fixed within the preferred embodiment. In reference to FIG. 2, the at least one anchoring feature 14 of the preferred embodiment comprises a stake flange 17 and a plurality of flange holes 18. More specifically, the stake flange 17 is perpendicularly connected across an upper section 3 of the elongated plate 2 thus extending halfway down the elongated plate 2. Additionally, the stake flange 17 and first arm 6 are oriented opposite of each other about the elongated plate 2. The plurality of flange holes 18 traverses through the stake flange 17 and evenly spaced apart from each other along the stake flange 17. The stake flange 17 provides necessary surface area within the preferred embodiment so that the stake flange 17 can be positioned against a wooden stake and fastened to the wooden stake through the plurality of flange holes 18 by screw fasteners or other similar types of fasteners. Furthermore, the stake flange 17 provides a fixed placement for the preferred embodiment as the elongated plate 2 is not able to move or pivot about the wooden stake. Since the stake flange 17 is not fully extended across the elongated plate 2, the preferred embodiment is able to retain some elastic deformation in between the first channel 8 and the second channel 9 in order to receive and secure the form mat.

Additionally, the preferred embodiment of the present invention further comprises a guide plate 24 that is angularly connected along the second channel 9, opposite of the second arm 7. In reference to FIG. 3, the guide plate 24 is angularly and terminally connected along the free wall 13 of the second channel 9 as the guide plate 24 and the free wall 13 of the second channel 9 are oriented at an acute angle 25. Since the elongated plate 2 is manufactured with a predetermined height, the guide plate 24 eases the insertion of the form mat into the first channel 8 and the second channel 9. More specifically, a top end of the form mat is first inserted into the first channel 8 angularly. Then, a bottom end of the form mat is place against the guide plate 24 and pushed into the second channel 9 thus securing the form mat within the first channel 8 and the second channel 9.

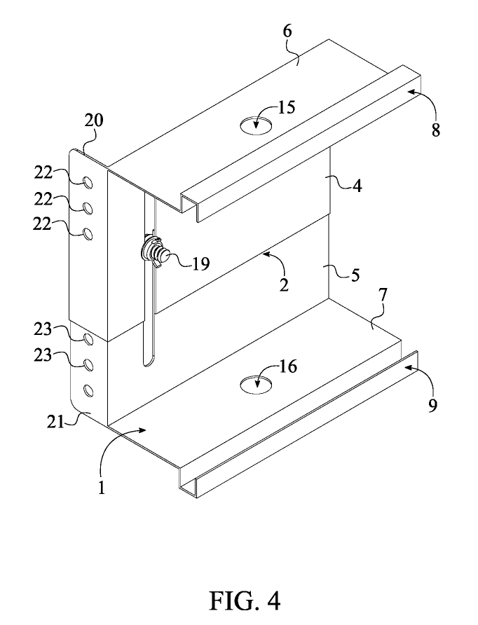

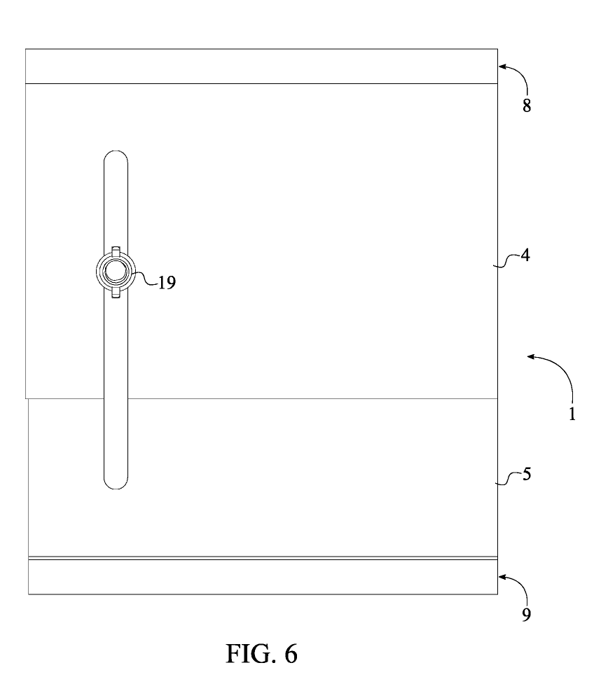

In reference to an alternative embodiment of the present invention, the elongated plate 2 comprises a top half 4 and a bottom half 5. The top half 4 and the bottom half 5 are slidably engaged with each other through a height-adjustable locking mechanism 19 as shown in FIG. 4-6. As a result, the distance between the first channel 8 and the second channel 9 can be adjusted according to the height of the form mat within the alternative embodiment. Preferably, the height-adjustable locking mechanism 19 of the alternative embodiment comprises a first track, a second track, and a clamp fastener. More specifically, the first track traverses through the top half 4, and the second track traverses through the bottom half 5. When the first track and the second track are aligned with each other, the clamp fastener is able to lock the top half 4 and the bottom half 5 together in such a way that the user is able to maintain the height of the alternative embodiment. The clamp fastener preferably comprises a bolt and a thumb nut within the alternative embodiment so that the user is able to easily locks the top half 4 and the bottom half 5 together. However, the clamp fastener is not limited to the bolt and the thumb nut and can include any other types of compatible fasteners such as, a male and female fastener, a magnetic fastener, and a latch fastener.

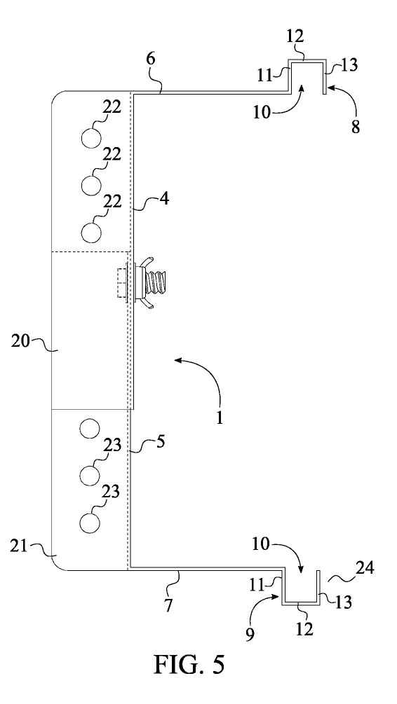

In reference to FIG. 4-5, the at least one anchoring feature 14 of the alternative embodiment comprises a first stake flange 20, a second stake flange 21, a plurality of first flange holes 22, and a plurality of second flange holes 23. More specifically, the first stake flange 20 is perpendicularly connected across the top half 4 as the first stake flange 20 and first arm 6 are oriented opposite of each other about the top half 4. The plurality of first flange holes 22 traverses through the first stake flange 20. As a result, the first stake flange 20 provides necessary surface area within the alternative embodiment so that the first stake flange 20 can be positioned against a wooden stake and fastened to the wooden stake through the plurality of first flange hole by screw fasteners or other types of similar fasteners. The second stake flange 21 is perpendicularly connected across the bottom half 5 as the second stake flange 21 and second arm 7 are oriented opposite of each other about the bottom half 5. The plurality of second flange holes 23 traverses through the second stake flange 21. As a result, the second stake flange 21 provides necessary surface area within the alternative embodiment so that the second stake flange 21 can be positioned against a wooden stake and fastened to the wooden stake through the plurality of second flange holes 23 by screw fasteners or other types of similar fasteners. Due to the positioning of the plurality of first flange holes 22 and the plurality of second flange holes 23, the top half 4 and the bottom half 5 of the alternative embodiment can be individually secured to a wooden stake thus maintaining the desired heighted attained through the height-adjustable locking mechanism 19. In reference to FIG. 1 and FIG. 4, the at least one anchoring feature 14 further comprises a first stake hole 15 and a second stake hole 16 within the present invention. The first stake hole 15 centrally traverses through the first arm 6, and the second stake hole 16 centrally traverses through the second arm 7. More specifically, the first stake hole 15 and the second stake hole 16 are concentrically positioned with each other so that a metal stake can be inserted through both the first stake hole 15 and the second stake hole 16, securing the present invention to the ground surface. Furthermore, the first stake hole 15 and the second stake hole 16 provide a pivotable placement for the present invention as the elongated plate 2 is able to pivot about a rotational axis of the metal stake.

Although the invention has been explained in relation to its preferred embodiment, it is to be understood that many other possible modifications and variations can be made without departing from the spirit and scope of the invention as hereinafter claimed.

What is claimed is:

1. A concrete form clip comprises:
a main clip body;
a first channel;
a second channel;
at least one anchoring feature;
the main clip body comprises an elongated plate, a first arm, and a second arm;
the first arm and the second arm being perpendicularly and terminally connected to the elongated plate;
the first channel being terminally connected along the first arm, opposite of the elongated plate;
the second channel being terminally connected along the second arm, opposite of the elongated plate; and
the at least one anchoring feature being integrated onto the main clip body.

2. The concrete form clip as claimed in claim 1, wherein the first arm and the second arm being oriented parallel to each other along the elongated plate.

3. The concrete form clip as claimed in claim 1, wherein a channel opening of the first channel and a channel opening of the second channel being oriented towards each other along the elongated plate.

4. The concrete form clip as claimed in claim 1 comprises:
the first channel and the second channel each comprises a fixed wall, a base, and a free wall;
the fixed wall of the first channel being perpendicularly connected to the first arm;
the fixed wall of the second channel being perpendicularly connected to the second arm;
the free wall being connected to the fixed wall by the base; and
the free wall being positioned parallel to the fixed wall.

5. The concrete form clip as claimed in claim 1 comprises:
the at least one anchoring feature comprises a first stake hole and a second stake hole;
the first stake hole centrally traverses through the first arm;
the second stake hole centrally traverses through the second arm; and
the first stake hole and the second stake hole being concentrically positioned with each other.

6. The concrete form clip as claimed in claim 1 comprises:
the at least one anchoring feature comprises a stake flange and a plurality of flange holes;
the stake flange being perpendicularly connected across an upper section of the elongated plate;
the stake flange and first arm being oriented opposite of each other about the elongated plate; and
the plurality of flange holes traverses through the stake flange.

7. The concrete form clip as claimed in claim 6 comprises:
a guide plate; and
the guide plate being angularly connected along the second channel, opposite of the second arm.

8. The concrete form clip as claimed in claim 7 comprises:
the guide plate being angularly connected along a free wall of the second channel; and
the guide plate and the free wall of the second being oriented at an acute angle.

9. concrete form clip as claimed in claim 1 comprises:
a height-adjustable locking mechanism;
the elongated plate comprises a top half and a bottom half;
the at least one anchoring feature comprises a first stake flange, a second stake flange, a plurality of first flange holes, and a plurality of second flange holes;
the top half and the bottom half being slidably engaged with each other through the height-adjustable locking mechanism;
the first stake flange being perpendicularly connected across the top half;
the first stake flange and first arm being oriented opposite of each other about the top half;
the plurality of first flange holes traverses through the first stake flange;
the second stake flange being perpendicularly connected across the bottom half;
the second stake flange and second arm being oriented opposite of each other about the bottom half; and
the plurality of second flange holes traverses through the second stake flange.
